(19) United States
(12) Patent Application Publication
(10) Pub. No.: US 2018/0015353 A1
(43) Pub. Date: Jan. 18, 2018

(54) Drive System for a Vehicle Driveable Directly by Muscle Force, Method for Changing a Roller of Such a Drive System and Production Method

(71) Applicant: Mellow Boards GmbH, Hamburg (DE)

(72) Inventor: Kilian GREEN, Munich (DE)

(21) Appl. No.: 15/549,078

(22) PCT Filed: Feb. 4, 2016
(86) PCT No.: PCT/EP2016/052385

§ 371 Date: Aug. 4, 2017

(30) Foreign Application Priority Data
Feb. 5, 2015 (DE) 10 2015 101 652.4

(51) Int. Cl. A63C 17/12; A63C 17/22; B29C 39/10; B29L 31/32

(52) U.S. Cl. CPC A63C 17/12; A63C 17/226; A63C 17/223; B29C 39/10; B29L 2031/32; A63C 2203/12

(57) ABSTRACT

The invention relates to a drive system for a vehicle drivable by muscle force, in particular for a skateboard, said drive system comprising at least one axle and at least one wheel (1) which has an electric motor (10), wherein the electric motor (10) comprises a stator (11), which can be connected to the axle, and a rotor (12) which is rotatable about the stator. The invention is characterised in that the wheel (1) has a roller (20) which forms a running surface (24), wherein the roller (20) is or can be replaceably connected to the rotor (12). The invention further relates to a method for changing a roller (20) of such a drive system and to a production method.

The invention relates to a drive system for a vehicle drivable by muscle force according to the preamble of claim 1. The invention further relates to a vehicle drivable by muscle force with such a drive system, a method for changing a roller of such a drive system, and a method for producing such a roller of the drive system. For example, a drive system of the kind mentioned at the outset is known from DE 10 2009 036 924 A1.

DE 10 2009 036 924 A1 describes a skateboard with two driving axles, wherein wheels are arranged on the respective driving axles. A respective electric motor can be arranged inside of one or several wheels as the hub motor. The skateboard can be electrically driven in this way. An accumulator or battery is provided for supplying energy to the hub motor, wherein the accumulator or battery is carried along in a vest or backpack of the operator. The accumulator or battery can conceivably also be secured to the skateboard itself.

Due to the torque applied by the electric motor to the wheel, operating such a skateboard with an electric motor increases wear on the running surface of the respective wheel. Because the electric motor is integrated into the wheel, replacing a worn wheel is expensive, and runs the risk of damaging the electric motor.

The object of the invention is to indicate a drive system for a vehicle drivable by muscle force, in particular for a skateboard, which is easy to handle and easy to maintain. It is further the object of the invention to indicate a vehicle drivable by muscle force, in particular a skateboard, with such a drive system, a method for changing a roller of a drive system, and a production method. According to the invention, this object is achieved in terms of the drive system by the subject matter of claim 1, in terms of the vehicle by the subject matter of claim 19, in terms of the method for changing a roller of a drive system by the subject matter of claim 20, and in terms of the method for producing the roller by the subject matter of claim 21.

In particular, the object is achieved by a drive system for a vehicle directly drivable by muscle force, in particular for a skateboard, wherein the vehicle has at least one axle and at least one wheel, which has an electric motor. The electric motor can comprise a stator, which can be connected to the axle. In addition, the electric motor can have a rotor that is rotatable around the stator. The wheel can further comprise a roller that forms a running surface. The roller preferably is or can be replaceably connected to the rotor.

The present invention proposes a drive system for a vehicle directly drivable by muscle force. Understood as directly drivable vehicles within the meaning of the present application in particular are vehicles not equipped with an angle gear for converting the muscle force of a user into kinetic energy. Referred to as vehicles directly drivable with muscle force are skateboards, scooters, inline skates or rollerblades, roller skates, snakeboards or waveboards. The vehicles mentioned within the framework of the application specifically denote pieces of sports equipment that can be made to move forward or backward by the muscle force of a single user, wherein the pieces of equipment can simultaneously carry the respective user.

In the invention, the drive system preferably has a replaceable roller. The part subject to heavy wear while operating the vehicle, specifically the roller comprising the running surface, can in this way be easily replaced. By contrast, other components of the drive system can continue to be operated. This significantly facilitates maintenance of the drive system. In addition, the replaceable roller allows the user to use different rollers, depending on the ground to be traversed or athletic requirements. In particular rollers with varying material compositions or surface structures can in this way be easily replaced, so as to adjust the vehicle to different external conditions. For example, it is easy to select a roller especially well-suited for a specific road surface or weather conditions. Therefore, the invention makes it possible to easily and quickly replace only the parts actually subject to wear. This reduces subsequent costs in relation to other systems from prior art, in which the entire drive unit, in particular to include the electric motor, must be replaced. The roller preferably is or can be positively connected with the rotor. This ensures that the torque acting on the rotor is readily transmitted to the roller. This improves the stability of the roller. In this way, transverse forces acting on the roller while negotiating curves can be readily dissipated. Such a transverse stability makes sense in particular when using the drive system on skateboards, since the latter are often used for tricks in which high transverse forces act on the wheels.

In particular, the roller can have at least one engaging element. The engaging element preferably positively engages into a receiving element of the rotor. The positive engagement via the engaging element on the one hand and the receiving element on the other hand makes it possible to easily and quickly assemble and disassemble the roller on the rotor.

In a preferred embodiment, the engaging element can consist of a polygonal interior circumferential surface of the roller. The receiving element is preferably designed complementarily thereto, so that a positive engagement can be established between the receiving element and engaging element. In particular, the receiving element can consist of a polygonal exterior circumferential surface. The polygonal interior and exterior surfaces make it easy to push the roller onto the rotor, and in the assembled state produce a positive fit in the circumferential direction.

In a preferred embodiment of the invention, the rotor has a bushing, in particular with a front plate. The bushing can encompass an essentially cylindrical circumferential wall, which is closed by the front plate along the longitudinal axis. The cylindrical circumferential wall is preferably comprised of a polygonal cylinder. The circumferential wall with the front plate can integrally yield the bushing.

The receiving element of the rotor can consist of a recess in the front plate of the bushing. Introducing a recess on the bushing or rotor into which an engaging element of the roller can engage ensures a good and stable connection between the roller and rotor. In particular, this makes it possible to ensure that a sufficiently large contact surface is provided between the engaging element and recess. This improves the stability of the positive connection. In this way, a torque of the electric motor can be readily conveyed from the rotor to the roller. Furthermore, this makes it possible to give the roller itself a comparatively thin-walled design, so that the electric motor can simultaneously be given large enough dimensions to provide a suitable drive power.

To provide as much installation space as possible inside of the wheel for the electric motor, it is further advantageous for the recess to be formed in a front plate of the rotor. The engaging element can then also be arranged or formed on the face of the roller. In this way, the connecting elements for coupling the roller with the rotor do not contribute to the overall diameter of the wheel, so that the installation space inside of the wheel can be readily utilized for arranging the electric motor.

In a preferred embodiment of the drive system according to the invention, the rotor is or can be connected with a retaining plate, which fixes the roller along a longitudinal axis. This contributes to the transverse stability of the roller, and makes it easier to replace the roller.

In particular, the engaging element can be positively fixed between a back surface of the recess and the retaining plate in an assembled state. At least portions of the retaining plate can abut against a front surface of the front plate, wherein a distance remains between the contact surface of the retaining plate and a back surface of the recess that essentially corresponds to a wall thickness of the engaging element. For example, the contact surface can be arranged in the area of openings that permit a screw connection between the retaining plate and front plate of the rotor.

Tight contact between the retaining plate and front plate ensures that the engaging element is rigidly fixed to the rotor, in particular clamped into the recess. In this regard, the retaining plate can have a clamping function to prevent the roller from slipping, which could lead to an undesirable handling.

The retaining plate can further have ventilation openings. As a result, the electric motor can be prevented from overheating. The retaining plate rotates together with the rotor during operation. This ensures that an air flow enters into the ventilation openings. The ventilation openings are preferably arranged in such a way as to allow air to both enter and exit. In an assembled state, air masses can be guided through the retaining plate and onto the front plate of the rotor by way of the ventilation openings. The front plate can have additional ventilation openings, so that the air masses are guided into the electric motor. In this way, the ventilation openings help to cool the electric motor.

Another embodiment can provide that the retaining plate be integrally designed with the roller. In this case, the roller is preferably connected with the rotor via a circumferential positive connection. In particular, the rotor encompasses a polygonal exterior circumferential surface, and the roller encompasses a complementary polygonal interior circumferential surface, which positively intermesh in the assembled state of the roller. The retaining plate preferably comprises a longitudinally axial end plate of the roller.

Another preferred configuration of the invention provides that the roller have a roller core made out of a first material. The roller can also have a jacket layer comprised of a second material. The jacket layer is preferably cast onto the roller core. Casting the jacket layer onto the roller core results in a fixed, essentially undetachable connection between the jacket layer and roller core. This yields a good torque transmission and prevents the jacket layer from undesirably detaching from the roller core. At the same time, the different materials can take into account the varied functions of the roller core and jacket layer. The roller core preferably serves to fix the roller onto the rotor of the electric motor. To this end, the roller core can have a comparatively hard material, for example a thermosetting plastic. By contrast, the job of the jacket layer is to establish a good contact with the road surface or traversed underlying surface. In this regard, it is advantageous that the material of the jacket layer have good adhesive properties. This is given in particular by comparatively soft materials, for example thermoplastic materials. In this regard, it can be provided that the jacket layer comprising the running surface of the roller have polyurethane or consist of polyurethane.

In this conjunction, it is conceivable that the roller core on an exterior surface be structured. For example, this structuring can be a nap structure, grooved structure or embossed structure. Structuring increases the contact surface available on the exterior surface of the roller core, thereby ensuring an improved adhesion of the second material comprising the jacket layer. The connection between the jacket layer and roller core is strengthened in this way.

The roller core functions to transfer the torque from the rotor to the roller especially well when the engaging element of the kind provided in a preferred configuration is integrally designed with the roller core. Another advantage to designing the engaging element integrally with the roller is that a standardized roller core can be provided, which can be furnished with various jacket layers, depending on customer requirements. This facilitates the serial production of a replaceable roller. In particular, a high number of rollers can be fabricated, wherein rollers with different rolling characteristics can be quickly and flexibly provided.

Advantageous embodiments of the drive system according to the invention further provide that the electric motor be coupled with a controller having a telemetry module. This expands the possibilities for controlling the drive system considerably. In particular, the telemetry module can be used to establish a wireless communication interface, for example with a manual control unit or a smartphone. The communication interface can be based on WLAN, Bluetooth, Zigbee or other wireless radio technologies. As a whole, the drive system can be remote controlled in this way, thereby eliminating the need for a connecting cable between the manual control unit and a drive system. This reduces the risk of accidents when using a vehicle equipped with the drive system.

The electric motor can further have at least one temperature sensor and/or at least one rotational speed sensor, which is or can be signal-connected with the controller. The temperature sensor and/or rotational speed sensor makes it possible to monitor the operation of the electric motor. In this way, the controller can be adjusted to initiate an emergency shutdown if a specific maximum temperature is exceeded. In addition, monitoring the rotational speed of the electric motor makes it possible to realize a speed regulator, but at the very least a speed display for the user. Finally, an operating state of the vehicle can be determined by monitoring the power consumption of the electric motor. For example, a suitable evaluation of sensor data makes it possible to determine whether the user is on the vehicle or has stepped off of the vehicle. In addition, the controller can be adjusted to prevent energy supply to the electric motor as soon as it has been detected that the user stepped off of the vehicle.

In general, the electric motor can have wiring. The wiring is preferably adjusted in such a way that the electric motor supplies a comparatively high torque. In other words, the electric motor can be torque-optimized. To this end, for example, the wiring has a winding pattern that is multipolar, in particular 12-polar. The winding pattern can have two star connections. Within the framework of the invention, it can also be provided that the wiring be connected with a circuit board, wherein the circuit board is longitudinally axially arranged inside of the stator.

This helps give the drive system a compact structural design. In addition, this yields a compact subassembly of the drive system, specifically the electric motor with wiring and circuit board, which can be easily replaced. This helps make the drive system more maintenance-friendly. The electric motor also becomes easier to assemble to the drive system, since only a single electrical plug connection with the circuit board need be established for electrically contacting the electric motor with an energy storage system, for example.

The drive system according to the invention can further have a base plate. The axle of the drive system can be mounted on the base plate. The base plate preferably has a receiving area for an accumulator. The base plate is or can be connected with the vehicle, in particular with a board of the skateboard, by screws. Using a base plate that carries essentially all components of the drive system yields a compact drive system.

The axle can be hinged to the base plate. Such a configuration makes sense in particular when using the drive system for a skateboard, wherein the hinged mount can be used for negotiating curves with the skateboard.

The drive system can have a total of two wheels, each with an electric motor. The electric motors can here be actuated separately from each other, for example to make negotiating curves easier. In addition, the controller can be adjusted to set an electronic differential lock, so that the wheels of the drive system rotate at the same speed.

A secondary aspect of the invention relates to a vehicle drivable by muscle force, in particular to a skateboard, which has at least one drive system described above. In this conjunction, reference is made to the fact that the term “skateboard” within the framework of the present application is used as a generic term for all types of leisure sports devices or vehicles comprising a board that can move on rollers. In particular, the term “skateboard” also encompasses longboards, streetboards, snakeboards and/or waveboards in the present application.

Also disclosed and claimed within the framework of the present invention is a method for replacing a roller of a drive system or vehicle described above, wherein the method comprises the following steps:
Releasing the connection between the roller and rotor, in particular releasing the retaining plate;
Removing the roller from the rotor;
Positively connecting a new roller with the rotor; and
Fixing the new roller onto the rotor, in particular with the retaining plate.

The method according to the invention for replacing a roller can be implemented easily and quickly, and thereby reduces the time required to replace a roller, the running surface of which is usually exposed to a high level of wear.

Further disclosed and claimed within the framework of the present invention is a method for manufacturing a roller for a drive system and/or vehicle described above, wherein the method comprises the following steps:
Providing a roller core made out of a first material;
Placing the roller core into a mold;
Casting a second material into the mold to form a jacket layer, wherein at least areas of the roller core are recast; and
Removing the roller from the mold.

The manufacturing method is flexible, and makes it possible to quickly react to varying requirements with regard to the rolling characteristics of the rollers to be produced. In particular, this makes it possible to quickly replace the material for the jacket layer when using standardized roller cores. The material for the jacket layer can be selected based on requirements concerning the rolling characteristics of the roller. For example, the jacket layer material selected for rollers used on asphalt can differ from that selected for rollers used for rolling on wood. The method according to the invention enables a quick replacement of materials, and thereby increases the level of automation during serial production.

A preferred variant of the method additionally provides that the mold have a multipart, in particular two-part, design, and be opened for removing the roller from the mold. This simplifies handling, and makes it easy to clean the mold.

The invention will be explained in more detail below based on an exemplary embodiment, with reference to the attached, schematic drawings. Shown therein:

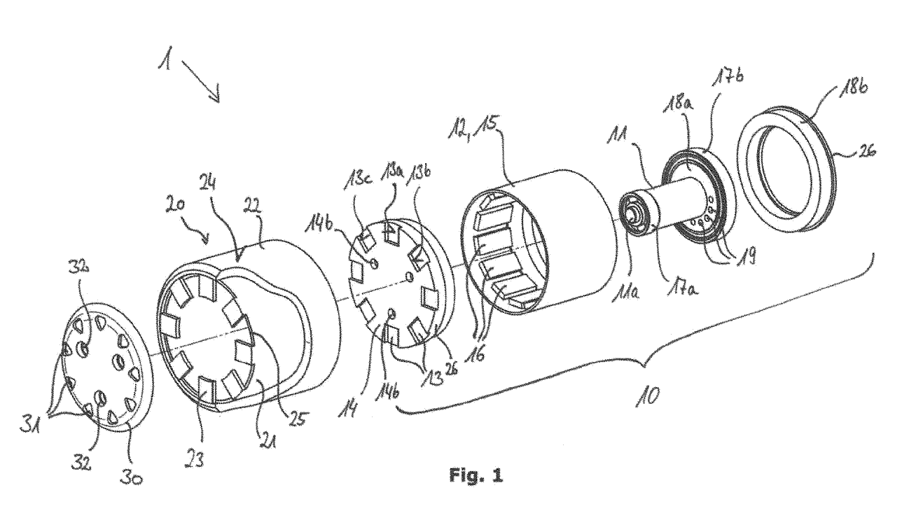

FIG. 1 is a perspective, exploded view of the wheel of a drive system according to the invention in a preferred exemplary embodiment, wherein part of the jacket layer of the roller has been removed for illustrative purposes;

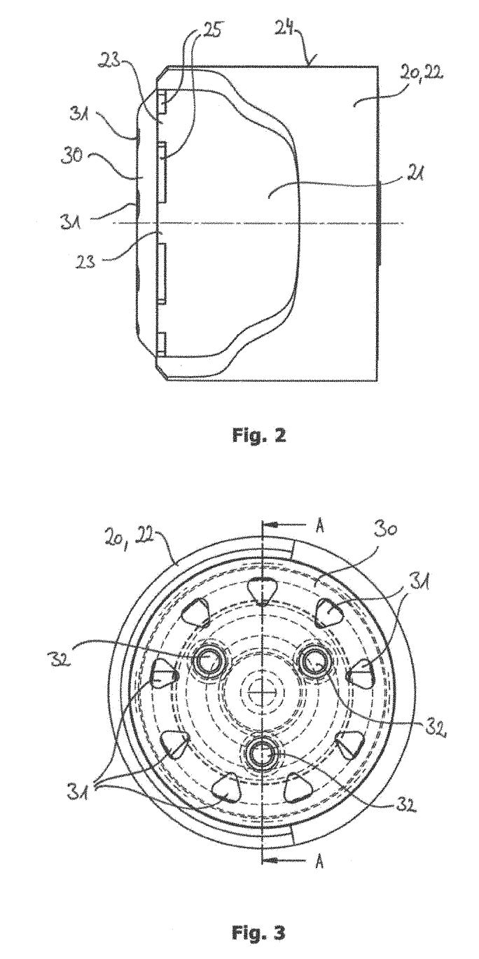

FIG. 2 is a side view of the wheel according to FIG. 1;

FIG. 3 is a front view of the wheel according to FIG. 1;

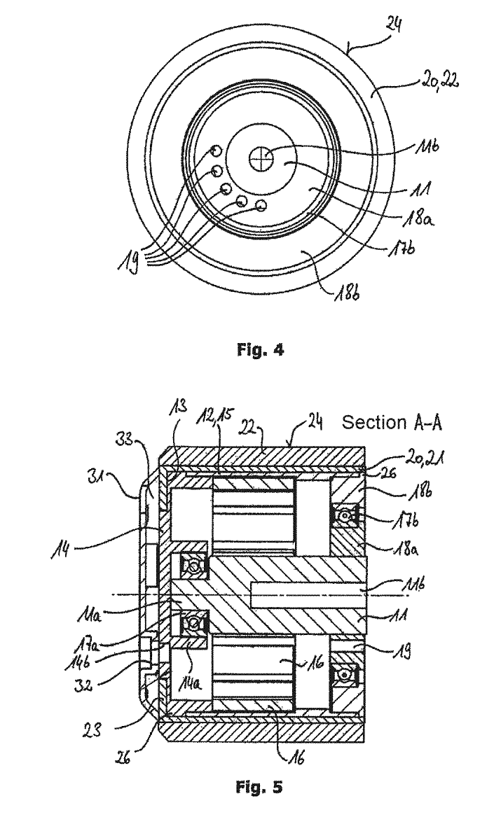

FIG. 4 is a rear view of the wheel according to FIG. 1;

FIG. 5 is a cross sectional view through the wheel according to FIG. 3 along the A-A line;

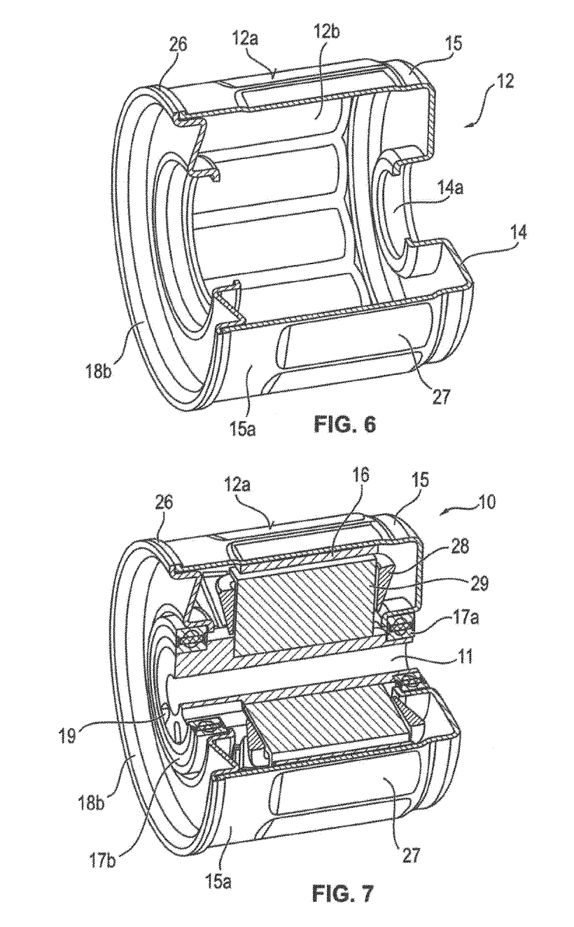

FIG. 6 is a perspective, partial sectional view of a rotor of a drive system according to the invention in another preferred exemplary embodiment; and

FIG. 7 is a perspective, partial sectional view of an electric motor of a drive system according to the invention with the rotor from FIG. 6.

FIGS. 1 to 5 show a wheel, which preferably is part of a drive system for a skateboard. The wheel can also be used as a drive system for longboards, streetboards, snakeboards, scooters, wakeboards or roller skates.

The wheel 1 comprises an electric motor 10 made up of a stator 11 and rotor 12. The stator 11 can preferably be fixedly connected with an axle of the drive system. In particular, the stator 11 can be screwed to an axle. The stator 11 is preferably fixed on the axle of the drive system using a thread-locking fluid, which prevents the screw connection between the stator 11 and axle of the drive system from inadvertently loosening.

The rotor 12 is pivoted in relation to the stator 11. In particular, an outer bearing 17a and an inner bearing 17b are provided, which rotatably connect the stator 11 with the rotor 12. The outer bearing 17a and inner bearing 17b preferably each comprise a deep groove ball bearing. The deep groove ball bearings can be sealed.

The rotor 12 has a bushing 15, which incorporates several permanent magnets 16. The permanent magnets 16 are preferably uniformly distributed over the inner circumference of the bushing 15 and fixedly connected with the bushing 15.

The rotor 12 further comprises a front plate 14, which seals the bushing 15 on the face. The front plate 14 can be inserted into the bushing 15 via an interference fit. The rear side of the bushing 15 is preferably sealed by a stator ring 18a, the inner bearing 17b and a bushing ring 18b. As a whole, this yields a well encapsulated electric motor 10, which is comparatively resistant to contamination or liquid entry.

In this conjunction, let it be noted that the wiring of the electric motor 10, i.e., the live windings for generating the dynamic magnetic field, have not been illustrated for reasons of clarity. The windings are preferably non-rotatably arranged on the stator 11. The windings are here designed in such a way that the electric motor 10 has a comparatively large torque. As a whole, the electric motor 10 has an optimized configuration in terms of torque so as to apply a sufficient driving force. This makes sense in particular because the electric motor 10 is preferably conceived as a gearless direct drive. The wiring of the electric motor 10 can be combined into a circuit board, which is fixedly arranged inside of the stator 11. This makes it easier to contact the electric motor 10 with an energy storage system, for example an accumulator or battery. For example, such an accumulator can be arranged on a base plate, wherein the base plate additionally carries the axle on which the electric motor 10 or wheel 1 is non-rotatably fixed.

Apart from the electric motor 10, the wheel 1 also encompasses a roller 20. The roller 20 is comprised of a roller core 21 and a jacket layer 22. The roller core 21 and jacket layer 22 can here have varying materials. The jacket layer 22 forms a running surface 24 on its outer circumferential surface. The jacket layer 22 is preferably fixedly cast with the roller core 21. As a consequence, there is an integral bond between the roller core 21 and jacket layer 22, which is characterized by an especially high stability.

As readily discernible on FIG. 1, the roller core 21 has engaging elements 23. The engaging elements 23 are plate-like in design, and extend radially to a longitudinal axis or rotational axis of the wheel 1. In particular, each engaging element 23 yields an extension in the longitudinal direction of the roller core 21 or projects over the roller core 21 in the longitudinal direction. Gaps 25 spaced apart from each other are arranged between the engaging elements 23 in the circumferential direction of the roller core 21. The engaging element 23 has an essentially rectangular outer contour.

As readily discernible on FIG. 2, the engaging elements 23 on the roller core 21 project over a cylindrical section of the roller core 21. Gaps 25 are formed between the individual engaging elements 23, into which the material of the jacket layer 22 can flow while casting the roller core 21. As a result, a positive connection is realized in addition to the integral bond between the jacket layer 22 and roller core 21. It is also possible that the outer circumferential surface of the roller core 21 be structured, for example have a grooved structure or nap structure, so that a good, in particular positive, connection is established with the jacket layer 22 while casting the roller core 21.

As a whole, several engaging elements 23 are distributed over the circumference of the roller core 21. The engaging elements 23 essentially form a gearing, wherein the individual teeth or engaging elements 23 are spaced apart uniformly from each other.

Recesses 13 are arranged on the front plate 14 complementarily to the engaging elements 23 on the roller 20 or on the roller core 21. As a whole, the front plate 14 has several recesses 12 on the face, which each exhibit an outer contour. Another number of recesses 13 is possible. The recess 13 and engaging element 23 are preferably dimensioned in such a way that the engaging element 23 engages into the recess 13 with a clearance fit.

In particular the recess 13 has a rear surface 13a, a floor surface 13b and two lateral surfaces 13c. The width of the lateral surfaces 13c essentially corresponds to the wall thickness of the engaging elements 23.

The recess 13 extends radially from an outer circumference of the front plate 14 toward the inside. The front plate 14 can have an outer diameter that essentially corresponds to the inner diameter of the roller core 21. It is here provided that the roller core 21 can be guided over the front plate 14 with a clearance fit.

A retaining plate 30 is provided to fix the positive connection between the roller 20 and rotor 12. The retaining plate 30 has an outer diameter that essentially corresponds to the outer diameter of the roller core 21. It is also possible for the retaining plate 30 to have an outer diameter larger than the outer diameter of the roller core 21, but smaller than the outer diameter of the jacket layer 22 or roller 20. The retaining plate 30 has fastening holes 32 that align flush with the threaded holes 14b in the front plate 14 in the assembled state. The fastening holes 32 and threaded holes 14b can be used to screw the retaining plate 30 with the front plate 14. In this way, the retaining plate 30 is non-rotatably coupled with the front plate 14 or rotor 12.

In the assembled state, at least parts of the retaining plate 30 abut flush against the front plate 14. In particular, it is provided that a distance be set between the retaining plate 30 and rear surface 13a of the recess 13 in the front plate 14 that essentially corresponds to the wall thickness of the engaging element 23. In this way, the engaging element 23 can be non-positively clamped between the front plate 14 and retaining plate 30 in addition to the positive connection. This improves the connection between the roller 20 and electric motor 10.

As readily discernible on FIG. 5, the retaining plate 30 abuts flush against the front plate 14 only with its outer edge and the fastening holes 32. In other words, the retaining plate 30 has a reshaped outer edge, so that a ventilation space 33 forms between the retaining plate 30 and front plate 14. Several ventilation openings 31 located in the retaining plate 30 empty into the ventilation space 33. The ventilation openings 31 are arranged on a circle, and spaced uniformly apart from each other. Nine ventilation openings 31 are provided in the exemplary embodiment shown.

An air flow that helps cool the electric motor 10 is generated through the ventilation holes 31 behind the retaining plate 30. The air here passes through the ventilation holes 31 and into the ventilation space 33 formed between the retaining plate 30 and front plate 14. The air can again exit the ventilation space 33 through the same ventilation openings 31.

Three fastening holes 32 are provided inside of the circle described by the ventilation openings 31. The front plate correspondingly has three threaded holes 14b. The threaded holes 14b and fastening holes 32 are each arranged at the same distance relative to the rotational axis of the wheel 1.

Visible on FIG. 4 is a rear view of the wheel 1. As evident, the stator 11 has an axial hole 11b. The axial hole 11b can encompass a thread. The axial hole 11b can be used to fix the stator 11 or entire wheel 1 on an axle. As further readily discernible, the stator ring 18a fixedly joined with the stator 11 has several openings. Each opening forms a cable outlet 19, so that the cables required for electrically contacting the stator 11 can be run out of the electric motor 10. Since the stator ring 18a is rigidly joined with the stator 11, and thus non-rotatably fixed on the axle, the provided arrangement of cable outlets 19 is here beneficial. A plug connector can also be arranged in the cable outlets 19. In general, the connection between the electric motor 10 and a controller can be established by two or more plug-connectable wiring harnesses. At least one plug connection can be arranged in the cable outlets 19, thereby enabling an easy electrical connection or disconnection directly at the electric motor 10.

The inner bearing 17b extends around the stator ring 18a, and can be designed as a deep groove ball bearing. Also provided to seal the electric motor 10 is the bushing ring 19b, which is fixedly connected with the bushing 15 of the rotor 12. In particular, the bushing ring 18b can be joined with the bushing 15 by way of an interference fit.

FIG. 5 shows a detailed illustration of the inner structural design of the wheel 1. Readily discernible in particular is the axial hole 11b of the stator 11. The axial hole 11b serves establish a connection with the axle of the drive system. In addition, the stator 11 comprises a pin 11a, which projects over the stator 11 along the longitudinal axis. The pin 11a carries the outer bearing 17a, which can be designed as a deep groove ball bearing.

The outer bearing 17a is fitted into an annular extension 14a of the front plate 14.

As further readily discernible on FIG. 5, both the front plate 14 and bushing ring 18b each have a radial flange 26, which projects over the bushing 15. This prevents dirt or dust from penetrating into the electric motor 10.

Finally, FIG. 5 clearly shows that the roller 10 consists of two parts. Visible in particular is the roller core 21, which has engaging elements 23 to positively connect the roller 20 with the rotor 12 of the electric motor 10. The roller 20 further comprises a jacket layer 22, which is in particular integrally joined with the roller core 21. The jacket layer 22 can consist of polyurethane, which is characterized by good adhesive characteristics. The jacket layer 22 makes up the running surface 24 of the roller 20. FIGS. 6 and 7 depict an alternative exemplary embodiment of the drive system, wherein in particular the structural design of the electric motor 10 is shown. FIG. 6 presents the rotor 12 of the electric motor 10 in a perspective, partial sectional view. The rotor consists of a bushing 15, which has an essentially cylindrical circumferential wall 15a and a front plate 14 integrally designed with the circumferential wall 15a. The front plate 14 seals the bushing 15 to the outside. In other words, the front plate is aligned on an axle relative to the longitudinally axial exterior side of the axle in the assembled state of the rotor 12. The front plate 14 incorporates an annular extension 14a that can accommodate a ball bearing.

The bushing 15 with the front plate 14 is preferably designed as an integral deep-drawn part. This makes the rotor 12 especially easy to manufacture. Provided on the side lying opposite the front plate 14 is a bushing ring 18b, which seals the bushing 15 on an axle toward the interior side in the assembled state of the rotor 12. In the area of the bushing ring 18b, the rotor 12, in particular the bushing 15, has a radial flange 26 that serves as a stop for a roller 20.

The circumferential wall 15a of the rotor 12 is essentially cylindrical in design, and at least sections thereof comprise a polygonal outer profile. In other words, the rotor 12 or bushing 15 has a polygonal outer circumferential surface 12a. The outer circumferential surface 12a forms a receiving element 27 for positively engaging a complementarily designed engaging element 23 of the roller 20. It is specifically provided that the replaceable roller 20 have an inner circumferential surface also having a polygonal design. In particular, several flattened circumferential wall sections can here be provided, which positively intermesh in the assembled state of the roller 20 on the rotor 12, wherein the positive connection comes about in particular in the circumferential direction. As readily discernible on FIG. 6, the interior side of the circumferential wall 15a is also provided with flat or flattened surfaces. These flattened surfaces yield magnetic receptacles 12b, so that flat or non-curved permanent magnets 16 can be easily glued onto the inner circumferential surface of the rotor 12. In this regard, the flattened areas of the circumferential wall 15a have a dual function. The flattened areas permit a positive connection with a replaceable roller 20 toward the outer circumferential surface 12a. The flattened areas form magnet receptacles 12 toward the inner circumferential surface for the easy and reliable accommodation of permanent magnets 16.

The roller 20 positively fixed with the rotor 12 in the circumferential direction via the polygonal outer contour of the bushing 15 can be connected in a longitudinally axial direction with the front plate 14 of the rotor 12, for example by a screw connection. In particular, the front plate 14 can be provided with holes (not shown here), in particular threaded holes, so as to fix the replaceable roller with a retaining plate 30 to the rotor 12. It can here be provided that the retaining plate 30 be integrally designed with the roller 20, in particular the roller core 21. In other words, at least the roller core 21 can also be designed as a deep-drawn part with an integrally designed retaining plate 30. The retaining plate 30 integrally designed with the roller core 21 preferably also has holes that align flush with the holes or threaded holes in the front plate 14 of the rotor 12, thereby enabling a screw connection between the roller core 21 and rotor 12.

FIG. 7 presents a perspective, partial sectional view of the electric motor 10, which has a rotor 12 according to FIG. 6. As evident, the permanent magnets 16 are arranged, in particular glued, into the magnet receptacles 12b. The stator 11 has wiring harnesses 19 at one inner axial end of the rotor 12. At the inner axial end, the rotor 12 is mounted so that it can be rotated relative to the bushing ring 18b by way of an inner bearing 17b designed as a ball bearing. At an outer axial end of the rotor 12, the stator 11 is mounted via an outer bearing 17 that is placed, in particular pressed, into the annular extension 14a of the rotor 12. The stator further has winding cores 29, which extend radially outward from the longitudinal axis of the stator 11, and carry windings 28.

In general, it is provided for the drive system that the electric motor 10, in particular the bushing 15, have an outer diameter that measures at most 80 mm, in particular at most 70 mm, in particular at most 65 mm, in particular 63 mm. This ensures that the wheel 1 with the roller 20 will have an overall diameter that essentially corresponds to commercially available skateboard rollers. As a result, existing skateboards or similar pieces of sports equipment can be easily retrofitted.

The length of the wheel 1 preferably measures at most 75 mm, in particular at most 72 mm, in particular at most 70 mm. This format also makes it easier to retrofit existing skateboards.

The entire drive system can additionally encompass a telemetry module, so that the electric motor 10 can be remote controlled. For example, a user can control the electric motor via his or her smartphone and a WLAN, Bluetooth or Zigbee connection. The electric motor 10 can further be adjusted to allow recuperative braking. The electric motor 10 can thus also act as a generator, wherein braking energy is converted into electrical energy, and returned to an energy storage system, for example an accumulator. This expands the range of the drive system.

### REFERENCE LIST

1 Wheel
10 Electric motor
11 Stator
11a Pin
11b Axial hole
12 Rotor
12a Outer circumferential surface
12b Magnet receptacle
13 Recess
13a Rear surface
13b Floor surface
13c Lateral surface
14 Front plate
14a Annular extension
14b Threaded hole
15 Bushing
15a Circumferential wall
16 Permanent magnet
17a Outer bearing
17b Inner bearing
18a Stator ring
18b Bushing ring
19 cable outlet
20 Roller
21 Roller core
22 Jacket layer
23 Engaging element
24 Running surface
25 Gap
26 Radial flange
27 Receiving element
28 Winding
29 Winding core
30 Retaining plate
31 Ventilation opening
32 Fastening hole
33 Ventilation space

1. A drive system for a vehicle drivable by muscle force, in particular for a skateboard, with at least one axle and at least one wheel (1), which has an electric motor (10),
characterized in that
the electric motor (10) comprises a stator (11), which can be connected to the axle, and a rotor (12) that is rotatable around the stator (11), and the wheel (1) has a roller (20) that forms a running surface (24), wherein the roller (20) is or can be replaceably connected to the rotor (12).

2. The drive system according to claim 1,
characterized in that
the roller (20) is or can be positively connected with the rotor (12).

3. The drive system according to claim 1 or 2,
characterized in that
the roller (20) has at least one engaging element (23), which positively engages into a receiving element (27) of the rotor (12).

4. The drive system according to claim 3,
characterized in that
the engaging element (23) consists of a polygonal inner circumferential surface of the roller (20), and
the receiving element (27) consists of a polygonal outer circumferential surface (12a) of the rotor (12).

5. The drive system according to one of the preceding claims,
characterized in that
the rotor (12) has a bushing (15) with a front plate (14).

6. The drive system according to claim 3,
characterized in that
the receiving element (27) consists of a recess (13) in the front plate (14) of the bushing (15).

7. The drive system according to one of the preceding claims,
characterized in that
the rotor (12) is or can be connected with a retaining plate (30) that fixes the roller (20) along a longitudinal axis.

8. The drive system according to claim 7,
characterized in that
the engaging element (23) is positively fixed between rear surface (13a) of the recess (13) and the retaining plate (30) in an assembled state of the roller (20).

9. The drive system according to claim 7 or 8,
characterized in that
the retaining plate (30) has ventilation openings (31).

10. The drive system according to one of the preceding claims,
characterized in that
the roller (20) has a roller core (21) made out of a first material and a jacket layer (22) made out of a second material, wherein the jacket layer (22) is cast onto the roller core (21).

11. The drive system according to claim 10,
characterized in that
the engaging element (23) is integrally designed with the roller core (21).

12. The drive system according to one of the preceding claims,
characterized in that
the electric motor (10) is coupled with a controller that has a telemetry module.

13. The drive system according to claim 12,
characterized in that
the electric motor (10) has a temperature sensor and/or rotational speed sensor that is or can be signal-connected with the controller.

14. The drive system according to one of the preceding claims,
characterized in that
the electric motor (10) has wiring that is connected with a circuit board, wherein the circuit board is longitudinally axially arranged inside of the stator (11).

15. The drive system according to one of claims 7 to 14,
characterized in that
the retaining plate (30) is non-rotatably coupled with the front plate.

16. The drive system according to claim 15,
characterized in that
the retaining plate (30) has fastening holes (32) that align flush with threaded holes (14b) in the front plate (14) in the assembled state.

17. The drive system according to one of claims 7 to 16,
characterized in that
at least parts of the retaining plate (30) abut flush against the front plate (14).

18. The drive system according to one of claims 5 to 17,
characterized in that
the bushing (15) has a cylindrical circumferential wall (15a), with which the front plate (14) is integrally designed, in particular as an integral deep-drawn part.

19. A vehicle drivable by muscle force, in particular a skateboard, with at least one drive system according to one of the preceding claims.

20. A method for changing a roller (20) of a drive system or vehicle according to one of the preceding claims, wherein the method consists of the following steps:
Releasing the connection between the roller (20) and rotor (12), in particular releasing the retaining plate (30);
Removing the roller (20) from the rotor (12);
Positively connecting a new roller (20) with the rotor (12); and
Fixing the new roller (20) to the rotor (12), in particular with the retaining plate (30).

21. The method for changing a roller (20) of a drive system and/or vehicle according to one of the claims 1 to 19, wherein the method consists of the following steps:
Providing a roller core (21) made out of a first material;
Placing the roller core (21) into a mold;
Casting a second material into the mold to form a jacket layer (22), wherein at least areas of the roller core (21) are recast; and
Removing the roller (20) from the mold.
